(19) United States
(12) Patent Application Publication
(10) Pub. No.: US 2019/0129040 A1
(43) Pub. Date: May 2, 2019

(54) METHOD AND APPARATUS FOR MAP INFERENCE SIGNAL RECONSTRUCTION

(71) Applicant: GM GLOBAL TECHNOLOGY OPERATIONS LLC, Detroit, MI (US)

(72) Inventors: Eric He, Pittsburgh, PA (US); Fan Bai, Ann Arbor, MI (US); Curtis L. Hay, West Bloomfield, MI (US); Vijayakumar Bhagavatula, Pittsburgh, PA (US)

(21) Appl. No.: 15/795,347

(22) Filed: Oct. 27, 2017

(51) Int. Cl. G01S 19/21; G01S 19/47

(52) U.S. Cl. CPC G01S 19/21; G01S 19/47

(57) ABSTRACT

The present application generally relates to methods and apparatus for inferring map data from GPS measurements. More specifically, the method and apparatus to receive a plurality of measurement data from vehicular GPS measurements and, optionally, additional sensor data. The system is then operative to generate latitude and longitude errors from the covariance matrix and apply this information to a plurality of measurement data in order to determine an actual location in response to the plurality of measurement data.

### BACKGROUND

The present application generally relates to vehicle control systems and autonomous vehicles. More specifically, the application teaches a method and apparatus for Signal Reconstruction for map inference using crowd-sourced GPS signals with error covariance matrix models.

### BACKGROUND INFORMATION

In general, an autonomous vehicle is a vehicle that is capable of monitoring external information through vehicle sensors, recognizing a road situation in response to the external information, and manipulation of a vehicle. Maps are an important source of information for autonomous vehicles. Maps are a primary source of information used for navigation, but conventional maps are also expensive and time consuming to make. Specialized equipment is used to collect accurate GPS data, and even still there are issues such as road misalignments and disconnections. Furthermore, new roads are constructed daily, lane patterns shift for various reasons, and old roads fall into disrepair beyond use. These map inaccuracies can cause major problems for autonomous vehicles.

One solution that has been explored in recent years is known as map inference, the process by which opportunistically collected data are used to infer a road map. Typically, map inference uses data from GPS samples which generally provides a larger amount of data available compared to manually created maps, as the popularity of smartphones and GPS navigators increases. The coverage of locales is larger, and data can be collected more frequently, allowing maps to update more often. A major problem with this method is that the accuracy of these GPS traces is much lower than what is used in manually made maps. Therefore, map inference methods are reliant on the amount of data available to compensate for the lower quality, which can become particularly poor in urban areas. It is therefore desirable to map roads using fewer data points while filtering out noise in order to increase accuracy.

The above information disclosed in this background section is only for enhancement of understanding of the background of the invention and therefore it may contain information that does not form the prior art that is already known in this country to a person of ordinary skill in the art.

### SUMMARY

Embodiments according to the present disclosure provide a number of advantages. For example, embodiments according to the present disclosure facilitate automated methods of map generation and refinement. This system may further be employed to generate other data and is not limited to vehicular maps or autonomous vehicles.

In accordance with an aspect of the present invention, an apparatus comprising a receiver for receiving a measured location wherein the measured location includes an actual location and a measurement noise and a measured sensor value wherein the measured sensor value includes a true sensor value at the actual location and a sensor noise, a processor for generating a covariance matrix in response to the measurement noise and the sensor noise, generating a latitude error and a longitude error in response to the covariance matrix, and determining the actual location in response to the latitude error, the longitude error and the measured location, a memory for storing the actual location, and a map generator for generating a map in response to the actual location, and a transmitter for transmitting the map to a vehicle control system.

In accordance with another aspect of the present invention, a method comprising receiving a measured location wherein the measured location includes an actual location and a measurement noise, generating a covariance matrix in response to the measurement noise and the sensor noise, generating a latitude error and a longitude error in response to the covariance matrix, and determining the actual location in response to the latitude error, the longitude error and the measured location.

In accordance with another aspect of the present invention, a method of map inference comprising receiving a plurality of measured locations wherein each of the plurality of measured locations includes an actual location and one of a plurality of measurement noise, receiving a plurality of measured sensor values wherein each of the plurality of measured sensor values includes a true sensor value at the actual location and one of a plurality of a sensor noise, generating a covariance matrix in response to the plurality of measurement noise and the plurality of sensor noise, generating a latitude error and a longitude error in response to the covariance matrix, determining the actual location in response to the latitude error, the longitude error and the measured location, and generating a map in response to the actual location.

The above advantage and other advantages and features of the present disclosure will be apparent from the following detailed description of the preferred embodiments when taken in connection with the accompanying drawings.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 shows an exemplary GPS data set graph according to an embodiment.

FIG. 2 shows an exemplary environment for additional vehicle sensor data collection according to an embodiment.

FIG. 3 shows a graphical representation of measurement and measurement error according to an embodiment.

FIG. 4 shows an exemplary apparatus for map inference signal reconstruction according to an embodiment.

FIG. 5 shows an exemplary method for map inference signal reconstruction according to an embodiment.

The exemplifications set out herein illustrate preferred embodiments of the invention, and such exemplifications are not to be construed as limiting the scope of the invention in any manner.

### DETAILED DESCRIPTION

The following detailed description is merely exemplary in nature and is not intended to limit the disclosure or the application and uses thereof. Furthermore, there is no intention to be bound by any theory presented in the preceding background or the following detailed description. For example, the algorithms, software and systems of the present invention have particular application for use on a vehicle. However, as will be appreciated by those skilled in the art, the invention may have other applications.

The present disclosure teaches a method and apparatus for extracting road-relevant information from crowd-sourced vehicle sensor data. The system is operative to estimate the locations of roads from GPS traces collected from many vehicles such that drivers/vehicles can be timely alerted about temporary road closures or diversions and other changes such as newly-constructed roads. Map inference from GPS traces can also replace or augment current map construction methods that are manual and thus may be costly and/or cumbersome. The main challenges in inferring maps from GPS traces are that GPS data has errors and is often highly under-sampled, for example, 1 sample every 15 seconds. In order to extract reliable map information from such erroneous and under-sampled data, it is desirable to leverage the power of crowd-sourcing. However, the samples from multiple vehicles will correspond to different spatial sampling rates because of different vehicle speeds and will be asynchronous because of lack of coordinated sampling strategies among these vehicles. A mechanism using multiple data source with varying data rate is discussed, which is aimed at reconstructing signals under such challenging constraints.

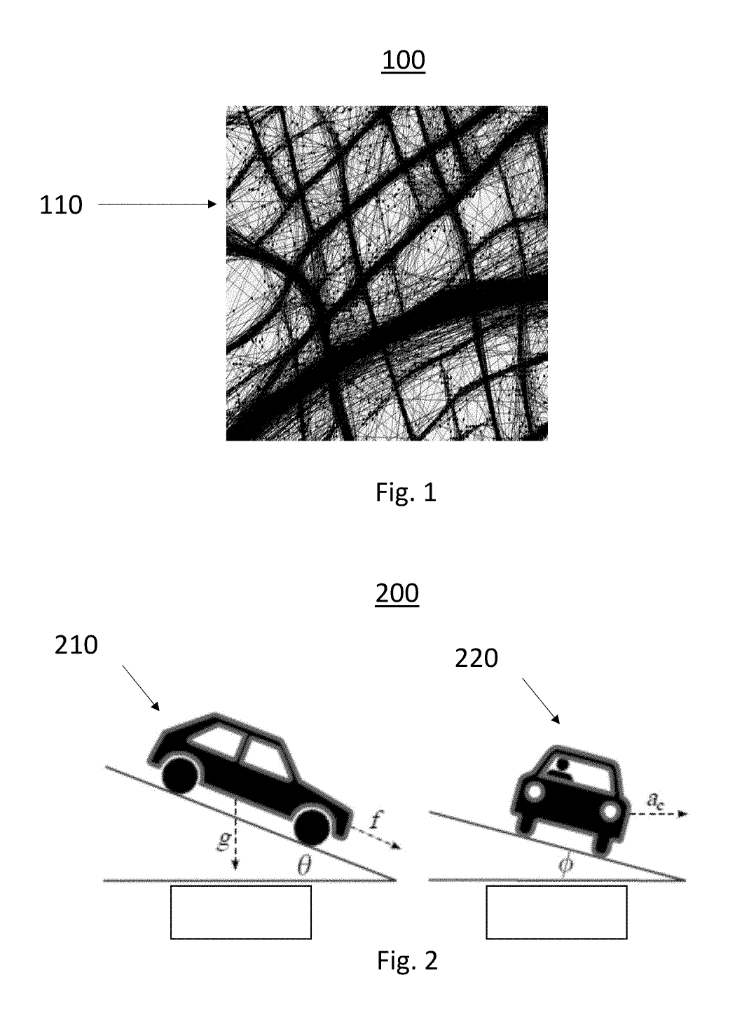

Turning now to FIG. 1 an exemplary GPS data set graph 100 according to the present invention is shown. The graph 110 shows millions of recorded GPS samples taken by vehicles traveling along roadways. The presently disclosed system and method develop and demonstrate algorithms to extract road-related information such as road maps from this crowd-sourced vehicle sensor data including GPS data and other vehicle sensor data. The method is then used to infer road maps from noisy vehicle data. The method may rely on only GPS data or may incorporate other vehicle sensor data, such as road grade data and/or accelerometer data.

The disclosed method may be operative using only GPS data or GPS data with additional vehicle sensor data. The availability of other vehicle sensor data such as accelerometer or other kinematic data may be used to increase the accuracy of GPS readings which may be much lower than what is required for maps used in autonomous driving systems. Therefore, methods that use GPS traces for map inference are reliant on the availability of large amount of data to compensate for the lower quality. The system may alternatively increase the amount of GPS data used for map inference and improve the quality of the map estimates by crowd-sourcing data from multiple vehicles. Heterogeneity of the vehicles and vehicle sensors as well as the asynchronous collection of GPS samples among the vehicles makes the signal reconstruction problem challenging.

Turning now to FIG. 2 an exemplary environment for additional vehicle sensor data collection 200 is shown. In the exemplary environment, angular data in both the front to back direction 210 and side to side direction 220 of the road surface may be measured by an onboard accelerometer. In an exemplary embodiment, this accelerometer information can be used with GPS information to determine a location based on the physical characteristics of the road.

In this exemplary method additional sensor are used such as accelerometer or steering wheel angle measurements, in order to improve the localization of the GPS measurements. This is done by constructing a function similar to that of the GPS only method, but utilizing this new data as well. For example, acceleration of the car will be a function of location, due to road roughness, elevation, and also traffic lights and stop signs. So it can be said that acceleration is a function of Latitude and Longitude. However, the locations where cars experience this acceleration are not arbitrary. Cars will only drive on roads, which is where this acceleration is experienced, and these roads can be represented as Latitude as a function of Longitude. Therefore, the method may represent acceleration and Latitude as a function of Longitude. Using samples of GPS and accelerometer readings, the method may then reconstruct this 3 dimensional signal. More generally, any signal which can be linked to location may be used in conjunction with GPS data, and we can even use multiple signals simultaneously in conjunction with GPS data. Using these signals, we can improve the 2D Latitude v Longitude signal due to the fact that this extra data is correlated with location. Furthermore, once an acceptably precise 3 dimensional signal is constructed, it can used to improve GPS readings in real time in conjunction with other sensors. By utilizing this additional data, along with the GPS data, the 3d signal held on a remote server can be cross-referenced to determine more accurately where the car is located.

When reconstructing this 3D signal, the method is operative to minimize the mean squared error (MSE) weighted by the inverse covariance matrix of the error terms. In this case, there are new error terms from the new sensor; however, given no other information, the method may assume these to be independent from each other and independent from the GPS errors, making the covariance matrix into the identity matrix which is a diagonal matrix with all ones along the diagonal and zeros everywhere else. When other information is available, using the previous error models, the method may employ a slightly modified inverse covariance matrix for the new purpose.

Another method of utilizing this data is to iteratively improve the inverse covariance matrix and the coefficient estimates. Certain values for the variances which are used to calculate the inverse covariance matrix may not be perfectly accurate in all cases, and so iteratively alternating between estimating the inverse covariance matrix and the coefficients for reconstruction may be employed to improve the performance of the method.

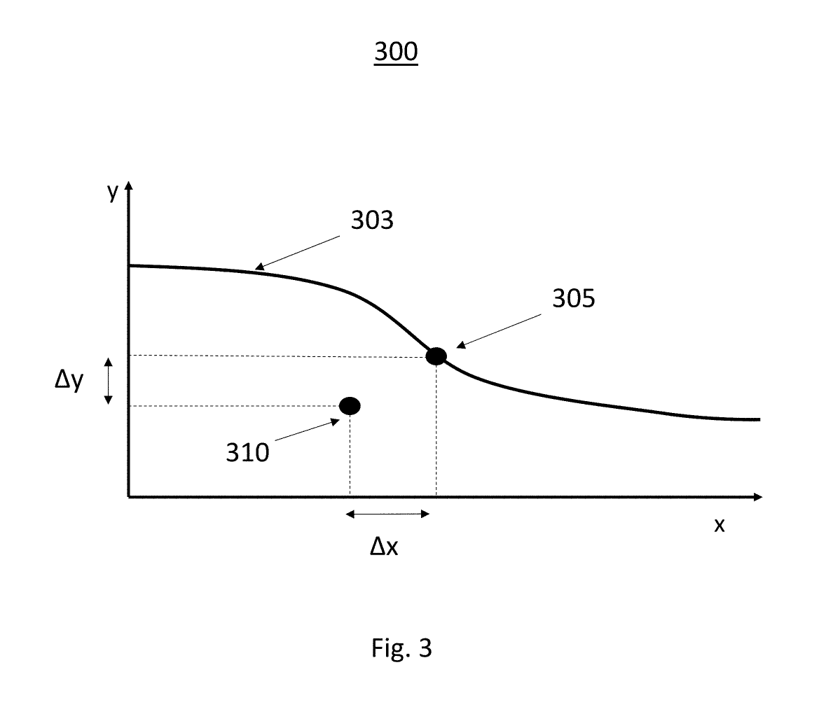

Turning now to FIG. 3, a graphical representation of measurement and measurement error 300 according to the present system is shown. The true location of the road segment 303 is shown with an actual location of a measurement 305 and a measured location value 310. The difference between the actual location 305 and the measured location 310 is shown as Δx and Δy. This difference may be attributed to errors in the GPS measurements and/or errors in the sensor data.

In a first exemplary method using GPS measurements the map inference is performed through signal reconstruction problem, where a road segment is modeled as a function to be reconstructed. For example, a road segment can be modeled as y=f(x) where x is the latitude and y is the longitude of the center line of that road segment. The shape of this function f(x) 303 describes the geometry of the road segment, and samples provided by GPS traces can be viewed as noisy samples from this f(x). The signal to be reconstructed is f(x), e.g., the latitude of the road segment as a function of the longitude. Let us say the vehicle sensor provides a reading at the true location 305. Ideally, the data pair corresponding to this location should be (q, f(q)) where q indicates the x-coordinate of the actual location 305. However, in reality, the data pair provided 310 would be (x,y) where x=q+Δx and y=f(q)+Δy. Here Δ denotes the location error introduced by the GPS inaccuracy and n denotes the sensor noise. The disclosed method employs an algorithm aimed at reconstructing the signal f(x) from crowd-sourced data pairs (x,y) from multiple vehicles and multiple sampling instants. For MSVR method, the sampling intervals do not have to be uniform or synchronous between the vehicles.

In the first exemplary method the road segment is modeled as y=f(x) where x is the latitude and y is the longitude of the center line of that road segment. As multiple vehicles traverse this road segment, they each provide a GPS trace corresponding to this road segment. When all such GPS traces are aggregated by a remote server a set of data pairs representing this road segment may be generated and used to reconstruct f(x).

In the signal reconstruction statistical models for the error terms Δ and n are utilized, where Δ and n correspond to longitude error and latitude error respectively. These error terms can be modeled as jointly Gaussian random variables where the means of these random variables is zero. If the GPS errors exhibit non-zero bias, then such a bias may be estimated and subtracted so that the errors can be modeled as zero-mean. For jointly Gaussian random variables Δ and n, the covariance matrix C associated with the samples may be estimated where a reasonable initial model for C is that it is a scalar multiple of I, the identity matrix. A more realistic model is that the GPS errors may depend on the location and time of the data collection where there is some correlation between Δ and n as both longitude and latitude estimates are computed from the same received signal and that might lead to some correlation between the corresponding errors Δ and n.

A second exemplary method uses other auxiliary vehicle data that is connected to GPS data. This additional data could be, for example, road grade data or steering wheel angle data or other types of sensor data. This second exemplary method involves constructing a function similar to that of the previous method, but utilizing the additional data also. For example, as shown in FIG. 2, the road grade is a function of location, i.e., the additional data (denoted by z) is a function g(q, f(q)) of latitude f(q) and longitude q. Using GPS samples and road grade samples, the 3-dimensional signal g(q, f(q)) may be reconstructed. More generally, any auxiliary signal which can be linked to the location can be used in conjunction with GPS data. In addition, multiple signals can be used simultaneously in conjunction with GPS data. The use of these signals may improve the estimation of the 2D Latitude v Longitude signal f(q). This improvement will be due to the relatively stable nature of the auxiliary signal z=g(q, f(q)).

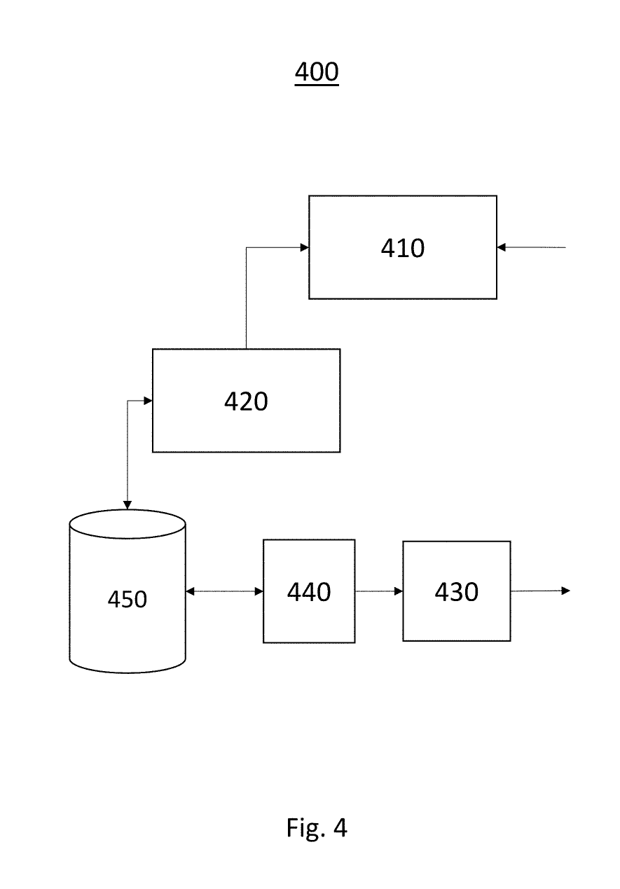

Turning to FIG. 4, an exemplary apparatus for map inference signal reconstruction 400 is shown. The exemplary apparatus comprises a receiver 410 for receiving data from vehicles. The receiver is operative to receive measurement data from many vehicles used to infer map data. The data may include a measured location wherein the measured location includes an actual location and a measurement noise and a measured sensor value wherein the measured sensor value includes a true sensor value at the actual location and a sensor noise. The receiver 410 may be an RF receiver for receiving a transmitted RF signal or may be a network interface for receiving the map data via a wireless or wired network.

The exemplary apparatus also includes a processor 420 for generating a covariance matrix in response to the measurement noise and the sensor noise, generating a latitude error and a longitude error in response to the covariance matrix, and determining the actual location in response to the latitude error, the longitude error and the measured location. The processor 420 generates the covariance matrix in response to the plurality of data received from vehicles. The exemplary system also uses a memory 450 for storing the received data, the actual location determined by the processor and/or map data generated by the map generator 440.

The map generator 440 is operative to retrieve the actual location data determined by the processor 420 and to generate a map in response to all the actual location data determined by the processor 420. Depending on the number of actual location data, the map generator may infer connections between the actual location data and may disregard location data that is determined to be not a driving surface.

Finally, the exemplary apparatus includes a transmitter 430 for transmitting the generated map data to a vehicle for use in a vehicle control system. The map data may be transmitted via a secondary server used to distribute map data or the like. The transmitter may be an RF transmitter for wireless transmission or may be a network interface for transmitting the map data via a wireless or wired network.

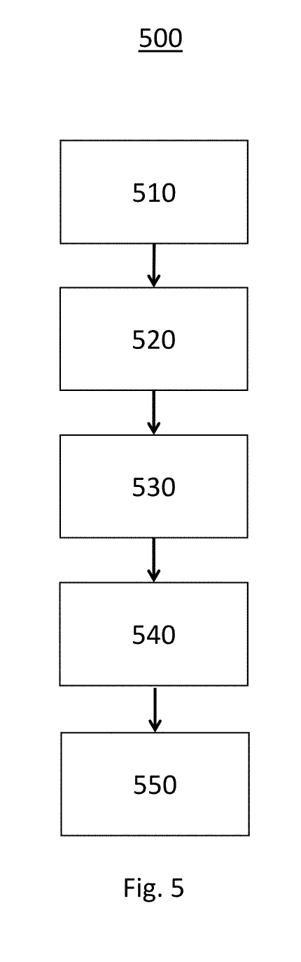

Turning to FIG. 5, an exemplary method for map inference signal reconstruction 500 is shown. The method is first operative to receive a measured location wherein the measured location includes an actual location and a measurement noise at a first time 510. The measured location may be determined from a GPS sensor on a vehicle or may be determined using sensor data along with the GPS sensor data to determine a location. The measured GPS sensor data includes an actual location and GPS measurement noise. The server stores this information along with information received from other vehicles.

The method may then optionally receive sensor data from a vehicle indicative of a location 520. The measured sensor value includes a true sensor value at the actual location and a sensor noise. This information may be received together with the previous GPS data or received separately. The sensor data may be processed by the vehicle to indicate a location along with the sensor data, such as accelerometer data.

The method is then operative to generate a covariance matrix in response to the measurement noise and the sensor noise 530. Each element of the covariance matrix is the covariance of that element. The covariance is a measure of the joint variability of two random variables. Therefore, for the exemplary method utilizing only GPS signals, the method generates a covariance matrix wherein the GPS error has a bias for each measured location received, which has a two dimensional Gaussian distribution and each sample has an independent and identically distributed noise component which follows a two dimensional Gaussian distribution. The method assumes that the distributions have a zero mean.

The method then generates a latitude error and a longitude error in response to the covariance matrix 540. Assuming that the vehicular bias term dominates the independent noise component, the method may assume there is only the bias term, which is two dimensional Gaussian distributed with the covariance matrix. Thus, a fixed, but random and independent for each measurement, offset may be generated for all sample locations from individual vehicles.

The method is then operative to determine the actual location in response to the latitude error, the longitude error and the measured location 550. Over many samples, the method may examine the Gaussian distribution of the errors of a location and determine the actual location by eliminating these errors. The method may then compile these actual measurements into a map, assuming that vehicles only drive on roads, to determine an up-to-date map. This map may then be used by autonomous driving system to locate driving surfaces and changes to the previously stored maps of driving surfaces.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

1. A method comprising:
receiving a measured location wherein the measured location includes an actual location and a measurement noise;
generating a covariance matrix in response to the measurement noise and the sensor noise;
generating a latitude error and a longitude error in response to the covariance matrix; and
determining the actual location in response to the latitude error, the longitude error and the measured location.

2. The method of claim 1 further comprising receiving a measured sensor value wherein the measured sensor value includes a true sensor value at the actual location and a sensor noise.

3. The method of claim 2 wherein the measured sensor value is generated in response to an accelerometer and a steering wheel sensor.

4. The method of claim 2 wherein the measured sensor value is generated by an accelerometer.

5. The method of claim 1 further comprising generating a map in response to the actual location.

6. The method of claim 5 further comprising transmitting the map to a vehicle.

7. The method of claim 5 further comprising transmitting the map to a vehicle control system.

8. The method of claim 1 wherein the actual location is determined in response to a plurality of measured locations.

9. The method of claim 1 wherein the measured location is determined in response to a global positioning system.

10. The method of claim 1 further comprising updating a map in response to the actual location.

11. A method of map inference comprising:
receiving a plurality of measured locations wherein each of the plurality of measured locations includes an actual location and one of a plurality of measurement noise;
receiving a plurality of measured sensor values wherein each of the plurality of measured sensor values includes a true sensor value at the actual location and one of a plurality of a sensor noise;
generating a covariance matrix in response to the plurality of measurement noise and the plurality of sensor noise;
generating a latitude error and a longitude error in response to the covariance matrix;
determining the actual location in response to the latitude error, the longitude error and the measured location; and
generating a map in response to the actual location.

12. The method of claim 11 wherein the plurality of measured sensor values are generated in response to an accelerometer and a steering wheel sensor.

13. The method of claim 11 wherein the plurality of measured sensor values is generated by an accelerometer.

14. The method of claim 11 further comprising transmitting the map to a vehicle.

15. The method of claim 11 further comprising transmitting the map to a vehicle control system.

16. The method of claim 11 wherein the actual location is determined in response to a plurality of measured locations.

17. The method of claim 1 further comprising updating a map in response to the actual location.

18. An apparatus comprising:
a receiver for receiving a measured location wherein the measured location includes an actual location and a measurement noise and a measured sensor value wherein the measured sensor value includes a true sensor value at the actual location and a sensor noise;
a processor for generating a covariance matrix in response to the measurement noise and the sensor noise, generating a latitude error and a longitude error in response to the covariance matrix, and determining the actual location in response to the latitude error, the longitude error and the measured location;
a memory for storing the actual location; and
a map generator for generating a map in response to the actual location; and
a transmitter for transmitting the map to a vehicle control system.

19. The apparatus of claim 18 wherein the plurality of measured sensor values are generated in response to an accelerometer and a steering wheel sensor.

20. The apparatus of claim 18 wherein the actual location is determined in response to a plurality of measured locations.
